(19) United States
(12) Patent Application Publication
(10) Pub. No.: US 2025/0378448 A1
(43) Pub. Date: Dec. 11, 2025

(54) TOKENIZED ACCOUNT ATTRIBUTES

(71) Applicant: Visa International Service Association, San Francisco, CA (US)

(72) Inventors: Mohammed Chakib Bouda, Schiedam (NL); Vinod Kumar Jothivelu, Nieuwegein (NL); Alfons David Welters, Leiden (NL); Barry Nannings, Zandvoort (NL); Todd Freyman, San Francisco, CA (US)

(73) Assignee: Visa International Service Association, San Francisco, CA (US)

(21) Appl. No.: 19/232,269

(22) Filed: Jun. 9, 2025

Related U.S. Application Data
(60) Provisional application No. 63/657,552, filed on Jun. 7, 2024.

(51) Int. Cl. G06Q 20/40

(52) U.S. Cl. CPC G06Q 20/405; G06Q 20/4016

(57) ABSTRACT

Techniques described herein include generating a first token for a first account associated with a first authorizing entity computer, the first token associated with a first attribute. The techniques further include generating a second token for a second account associated with a second authorizing entity computer. The techniques further include assigning a first transaction rule to the second token. The techniques further include assigning a first attribute value to the first attribute associated with the first token. The techniques further include receiving a request to check the first attribute value of the first attribute against the first transaction rule. The techniques further include responsive to the first attribute value of the first attribute satisfying the first transaction rule, transmitting a first validation message to the second authorizing entity computer.

### CROSS-REFERENCES TO RELATED APPLICATIONS

This application claims priority to U.S. Provisional Application No. 63/657,552, filed on Jun. 7, 2024, which is herein incorporated by reference in its entirety for all purposed.

### BACKGROUND

Rates of fraudulent transactions continue to increase including in the real-time or near real-time funds transfers between people or entities. Further, those conducting fraudulent transactions have become more sophisticated and use techniques to mitigate their likelihood of detection. Many entities are beginning to apply multiple fraud detection solutions, including the latest in predictive artificial intelligence (AI) technology, to flag risky transactions. These solutions can also increase false positives that block legitimate transactions thereby impacting resources (e.g., processing power) to identify and remedy false positives.

Embodiments of the disclosure address these problems and other problems individually and collectively.

### BRIEF SUMMARY

One embodiment of the invention includes a method comprising: generating a first token for a first account associated with a first authorizing entity computer, the first token associated with a first attribute; generating a second token for a second account associated with a second authorizing entity computer; assigning a first transaction rule to the second token; assigning a first attribute value to the first attribute associated with the first token; receiving a request to check the first attribute value of the first attribute against the first transaction rule; and responsive to the first attribute value of the first attribute satisfying the first transaction rule: transmitting a first validation message to the second authorizing entity computer.

One embodiment of the invention includes a system (e.g., a token service computer) comprising: one or more storage media storing instructions; and one or more processors configured to execute the instructions to cause the system to perform operations comprising: generating a first token for a first account associated with a first authorizing entity computer, the first token associated with a first attribute; generating a second token for a second account associated with a second authorizing entity computer; assigning a first transaction rule to the second token; assigning a first attribute value to the first attribute associated with the first token; receiving a request to check the first attribute value of the first attribute against the first transaction rule; and responsive to the first attribute value of the first attribute satisfying the first transaction rule: transmitting a first validation message to the second authorizing entity computer.

One embodiment of the invention includes one or more non-transitory computer-readable storage media storing instructions that, upon execution by one or more processors of a system (e.g., a processing network computer), cause the system to perform operations comprising: generating a first token for a first account associated with a first authorizing entity computer, the first token associated with a first attribute; generating a second token for a second account associated with a second authorizing entity computer; assigning a first transaction rule to the second token; assigning a first attribute value to the first attribute associated with the first token; receiving a request to check the first attribute value of the first attribute against the first transaction rule; and responsive to the first attribute value of the first attribute satisfying the first transaction rule: transmitting a first validation message to the second authorizing entity computer.

A better understanding of the nature and advantages of embodiments of the present invention may be gained with reference to the following detailed description and accompanying drawings.

### BRIEF DESCRIPTION OF THE DRAWINGS

FIG. 1 illustrates a block diagram of a system, according to certain embodiments.

FIG. 2 is a flow diagram for configuring attributes and transaction rules associated with tokens, according to certain embodiments.

FIG. 3 illustrates an exemplary relationship between accounts, tokens, transaction rules, and account attributes, according to certain embodiments.

FIG. 4 is a flow diagram illustrating validation of transaction attributes, according to certain embodiments.

FIG. 5 illustrates an example system determining that the first transaction rules are satisfied by the second account attributes, according to certain embodiments.

FIG. 6 illustrates an example system determining that the second account attributes fail satisfy the first transaction rules, according to certain embodiments.

FIG. 7 illustrates a simplified block diagram of a user device that may be used with embodiments of the present disclosure.

FIG. 8 illustrates a simplified block diagram of a token service computer that may be used with embodiments of the present disclosure.

FIG. 9 illustrates a simplified block diagram of a computer system that may be used with embodiments of the present disclosure.

### TERMS

Before discussing embodiments of the invention, some description of some terms may be helpful.

A “user” may include an individual and/or entity. In some embodiments, a user may be associated with one or more personal accounts and/or mobile devices. The user may also be referred to as a cardholder, account holder, or consumer in some embodiments.

A “user device” may be a device that is operated by a user. Examples of user devices may include a mobile phone, a smart phone, a card, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A user device may include a contactless device (e.g., a device that can communicate over a near field communication (NFC) antenna). A contactless device may include any smart device or form factor containing an NFC antenna that can transmit information to another smart device through the NFC antenna. Examples of contactless devices may include, but is not limited to, mobile phones, smart watches, smart wearables, TVs, laptops, payment cards (debit, credit, prepaid others), badges, tags, key fobs, home assistant devices, soundbars, refrigerators, cars, IoT devices etc.

A “resource” can be something of value to a user. A resource, for example, can include digital items and/or physical items. A resource can be an obtainable item. A resource can be owned by an entity. A resource can be a physical item such as goods. A resource can be a service that is provided by a merchant. A resource can be a digital item such as non-fungible tokens, secure data, etc. Another example of a resource is a secure location.

A “resource provider” may be an entity that can provide resources to a user. Examples of resource providers include entities that provide secure data (e.g., government entities), access to goods and services (e.g., merchants), access to locations (e.g., transit providers), etc. A “resource provider computer” may include any computer operated by a resource provider. In some embodiments, the resource provider computer may be an application server or a Web server operating a Website.

An “acquirer” may be a financial institution associated with a resource provider. Acquirers typically provide resource providers with a bank account, and in some cases, transaction accepting infrastructure. Generally, after a transaction has been authorized and as part of the settlement process, funds are transferred from the issuer to resource provider's account at the acquirer. The acquirer may also communicate a payment transaction status with the resource provider. The acquirer may operate an acquirer computer, which may generically be a transport computer.

An “authorizing entity” may be an entity that authorizes a request. Examples of an authorizing entity may be an issuer, a governmental agency, a document repository, an access administrator, etc. An authorizing entity may operate an authorizing entity computer.

A “payment processing network” may be data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. Payment processing networks such as VisaNet™ may provide support for the funds transfer operations between accounts and issuers of the accounts. Authorization, settlement, and clearing may be done at the same time (substantially simultaneously, e.g., within a few minutes or hours) or may be done as part of a batch settlement process (e.g., at the end of the day or week). The payment processing network may include a server computer. The payment processing network may use any suitable wired or wireless network, including the internet.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron, and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes, and other login information, etc. Other examples of credentials include PANs (primary account numbers), PII (personal identifiable information) such as name, address, and phone number, driver's license ID, social security number, and the like.

“Payment credentials” may include any suitable information associated with an account (e.g., a payment account and/or payment device associated with the account). Such information may be directly related to the account or may be derived from information related to the account. Examples of account information may include a bank account number, IBAN (International Bank Account Number), current account, checking account, savins account, sort code, routing number, BSB (Bank State Branch), BIC (Bank Identifier Code), clearing code, branch code, PAN (primary account number or “account number”), username, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a username, an expiration date, a gift card number or code, and any other suitable information.

“Access data” may include any suitable data that can be used to access a resource or create data that can access a resource. In some embodiments, access data may be a credential (e.g., a payment credential), a token, or some other type of information that can be used to access a resource. Such access data may be ticket information for an event, data to access a building, transit ticket information, etc. In yet other embodiments, access data may include data used to obtain access to sensitive data. Examples of access data may include codes or other data that are needed by a server computer to grant access to the sensitive data.

A “token” may be a substitute value for a credential. A token may be a string of numbers, letters, or any other suitable characters. A token may be bound to one or more devices (e.g., a user device). The token may comply with payment standards for use on instant payments, ACH, wire, and/or cross-border networks. Examples of tokens include access tokens, payment tokens, personal identification tokens, etc.

A “token service system” or alternatively a “token service computer” can include a system that services tokens. In some embodiments, a token service system can facilitate requesting, determining (e.g., generating) and/or issuing tokens, as well as maintaining an established mapping of tokens to access data, transaction attributes, and/or transaction rules (also referred to as “domain controls”) in a repository (e.g., token vault). In some embodiments, the token service system may establish a token assurance level for a given token to indicate the confidence level of the token to access data binding. The token service system may include or be in communication with a token vault where the generated tokens are stored. The token service system may support token processing of transactions submitted using tokens by detokenizing the tokens to obtain the actual access data. The token service system may support processing transaction attributes against transaction rules. In some embodiments, a token service system may include a tokenization computer alone, or in combination with other computers such as a transaction processing network computer. Various entities of a tokenization ecosystem may assume the roles of the token service system. For example, processing networks and issuers or their agents may become the token service system by implementing the token services.

The term “validation,” “verification,” and its derivatives may refer to a process that utilizes information to determine whether an underlying subject is valid under a given set of circumstances. Verification may include any comparison of information to ensure some data or information is correct, valid, accurate, legitimate, and/or in good standing.

A “server computer” is typically a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “communication channel” can include a medium through which message(s) can be provided. A communication channel can include a physical transmission medium (e.g., a wire, a contact interface, etc.), an over-the-air communication medium (e.g., using electromagnetic signals, etc.), a logical medium (e.g., application programming interfaces (APIs), etc.), and/or a combination thereof.

A “transaction” may be any interaction or exchange between two or more parties. For example, a transaction may include a first entity requesting resources from a second entity. In this example, the transaction is completed when the resources are either provided to the first entity or the transaction is declined.

An “interaction” may include a reciprocal action or influence that involves more than one actor. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like.

An “issuer” may typically refer to a business entity (e.g., a bank) that maintains an account for a user. An issuer may also issue payment credentials stored on a user device, such as a cellular telephone, smart card, tablet, or laptop to the consumer.

An “authorizing entity” may be an entity that authorizes a request. Examples of an authorizing entity may be an issuer, a governmental agency, a document repository, an access administrator, etc.

An “application” may be computer code or other data stored on a computer readable medium (e.g., memory element or secure element) that may be executable by a processor to complete a task.

### DETAILED DESCRIPTION

Embodiments are generally directed to techniques that enable tokens associated with accounts to be associated with transaction rules and attributes. Such associations with tokens can enable one or more attributes associated with a first token related to a transaction to be checked against one or more rules associated with another token related to the same transaction. The attributes may assist a determination regarding whether the transaction should be performed. For example, a sender may determine not to send money to a specific recipient account associated with a recipient token if the recipient token is associated with attributes that indicate the account is overseas and recently created. The attributes and/or rules associated with sender tokens and/or recipient tokens can improve transaction security and provide information about an account to a counterparty so the counterparty can make a more informed decision regarding whether to conduct a transaction.

To solve existing problems, account insights may be shared between authorizing entities of payors/senders and payees/recipients. Sharing account insights can help recipient entities (e.g., a person, a merchant, etc.) and sender entities (e.g., a person, a business, etc.) make more informed transaction decisions, manage false positive rates, and manage fraud risk. Embodiments further control how much information to share and when the information is shared.

By enabling the recipient entities and the sender entities to have more information on a counterparty (sender and recipient, respectively) account in their decision to initiate or accept a transaction can provide further risk mitigation to the entities involved in the transaction.

Personally Identifiable Information (PII) data protection laws often limit what recipient entities and sender entities can share. However, entities can share non-PII ‘insights’ associated with accounts with other entities that are useful for making more informed transaction decisions (e.g., how trusted or risky is the account a payment is about to be sent to or received from?). Non-PII insights can include a result of checking an attribute and/or attribute value against a transaction rule. The result is shared instead of the underlying information used to determine the result so that the attributes and/or attribute values can remain obscured to a counter party. Non-PII insights can include a type of account, a time in good standing, and an account velocity, among others. In an example, the account velocity is the number of transactions (sent and/or received) in a specified period of time (e.g., five transactions per minute). As used herein, a transaction may include funds transfer between entities, sometimes related to an underlying exchange of goods or services.

Details of some embodiments of the present disclosure will now be described in greater detail. For clarity, a certain number of components are shown in the subsequent figures. It is understood, however, that embodiments of the disclosure may include more than one of each component. In addition, the components in each figure may communicate via any suitable communication medium (including the internet, NFC, etc.), using any suitable communication protocol.

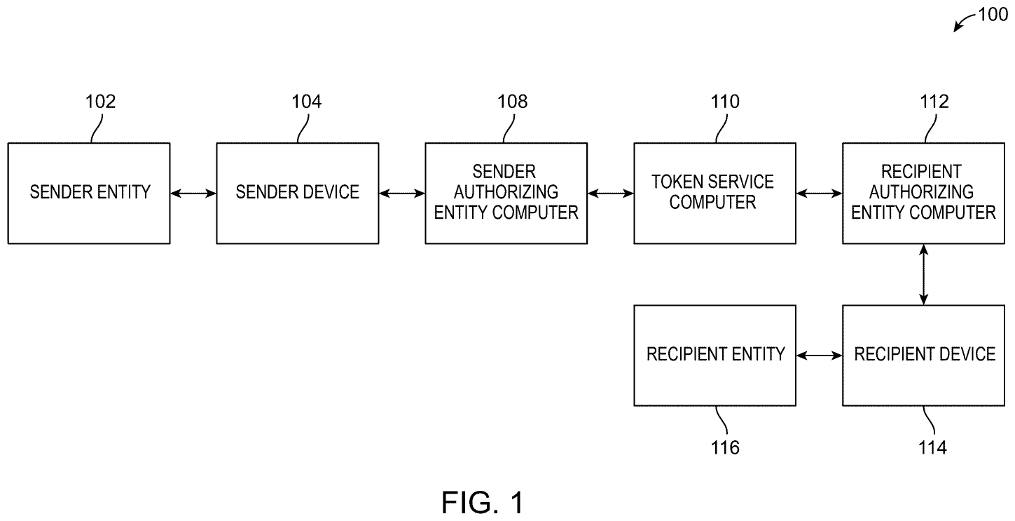

FIG. 1 illustrates a block diagram of a system 100, according to certain embodiments. The system 100 may comprise a sender entity 102 operating a sender device 104. The sender device 104 can be in communication with a sender authorizing entity computer 108 and/or a token service computer 110. The system 100 may comprise a recipient entity 116 operating a recipient device 114. The recipient device 114 can be in communication with a recipient authorizing entity computer 112 and/or the token service computer 110.

Each of the devices and computers may be in operative communication with each other. For simplicity of illustration, a certain number of components are shown in system 100. It is understood, however, that embodiments of the invention may include more or less components than are illustrated in system 100. For example, although one token service computer 110 is illustrated in FIG. 1, other systems can have many token service computers. For example, token service computers may be maintained by different token providers and an acquiring entity may use one or more token providers.

Any of the devices in system 100 may be in communication via a suitable communications network. The communications network may include a direct interconnection; the Internet; a Local Area Network (LAN); a Metropolitan Area Network (MAN); an Operating Missions as Nodes on the Internet (OMNI); a secured custom connection; cellular networks (e.g., using 3GPP standards such as 4G/5G); a Wide Area Network (WAN); a wireless network (e.g., employing protocols such as, but not limited to a Wireless Application Protocol (WAP), I-mode, and/or the like); and/or the like. Messages between the entities, providers, networks, and devices illustrated in system 100 may be transmitted using secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

The sender entity 102 may be associated with one or more accounts (e.g., personal accounts) and/or sender devices (e.g., sender device 104). The sender entity 102 may interface with the sender authorizing entity computer 108 using sender device 104. The sender entity 102 may provide input to cause a transaction to be initiated from the sender authorizing entity computer 108 to the recipient authorizing entity computer 112. The input may be provided to the sender device 104 using a user interface of the sender device 104. The input may be provided to the sender device 104 using a communications network. The transaction caused by the sender entity 102 may include a transfer of funds from a sender account associated with the sender entity 102 to a recipient account associated with the recipient entity 116. The sender authorizing entity computer 108 may manage the sender account. The recipient authorizing entity computer 112 may manage the recipient account.

The sender entity 102 may provide input to the sender authorizing entity computer 108 to cause a transaction to be initiated from the sender authorizing entity computer 108 to the recipient authorizing entity computer 112. The sender entity 102 may use sender device 104 to configure a set of account attributes associated with the sender account managed by the sender authorizing entity computer 108.

The sender device 104 may be operated by the sender entity 102. The sender device 104 may be, for example, a user device such as a mobile phone or a laptop computer. The sender entity 102 may be associated with the sender account managed by the sender authorizing entity computer 108. The sender device 104 may store an account identifier or a token representing the account identifier. The sender entity 102 may be associated with one or more tokens managed by and/or received from the token service computer 110.

The recipient entity 116 may be associated with one or more accounts (e.g., personal accounts) and/or recipient devices (e.g., recipient device 114). The recipient entity 116 may interface with the recipient authorizing entity computer 112 using the recipient device 114. The recipient entity 116 may provide input to cause the recipient authorizing entity computer 112 to request the sender device 104, the sender entity 102, and/or the sender authorizing entity computer 108 to initiate a transaction to the recipient authorizing entity computer 112. The input may be provided to the recipient device 114 using a user interface of the recipient device 114. The input may be provided to the recipient device 114 using a communications network.

The recipient entity 116 may use recipient device 114 to configure a set of account attributes associated with the recipient account associated with the recipient entity 116 and managed by the recipient authorizing entity computer 112.

The recipient device 114 may be operated by the recipient entity 116. The recipient device 114 may be, for example, a user device such as mobile phone or a laptop computer. The recipient entity 116 may be associated with the recipient account managed by the recipient authorizing entity computer 112. The recipient device 114 may store an account identifier or a token representing the account identifier. The recipient entity 116 may be associated with one or more tokens managed by and/or received from the token service computer 110.

The token service computer 110 may maintain tokens. The tokens may be associated with an account of the sender entity 102 (e.g., the sender account), the recipient entity 116 (e.g., the recipient account), or one or more other users. The tokens may be payment tokens. The tokens may be associated with the sender authorizing entity computer 108 or the recipient authorizing entity computer 112. The tokens may be associated with a set of account attributes and/or a set of transaction rules. The token service computer 110 may add, remove, and/or update the set of account attributes and/or a set of transaction rules associated with a token. The token service computer 110 may retrieve account data from memory (e.g., local and/or remote). The memory may be the memory of the token service computer 110 and/or an issuer computer.

The token service computer 110 may check transaction rules of an account against the attributes of a counterparty (e.g., another account) and/or the attributes of a transaction. In an example, the counter party of the sender entity 102 is the recipient entity 116, and the counterparty of the recipient entity 116 is the sender entity 102. The result of the check performed by the token service computer 110 may determine whether the transaction should move forward or be stopped. For example, if the account/token attributes associated with a first account/token satisfy the rules associated with a second account/token and/or the transaction within a predetermined acceptable tolerance level, the token service computer 110 may approve the transaction to move forward.

In certain embodiments, system 100 includes a processing network gateway. The processing network gateway may route messages between the sender authorizing entity computer 108 and a processing network. The processing network may perform process interactions such as transactions. In some embodiments, the processing network may be a payment processing network, and may manage the token service computer 110. In certain embodiments, the recipient entity 116 may be a resource provider.

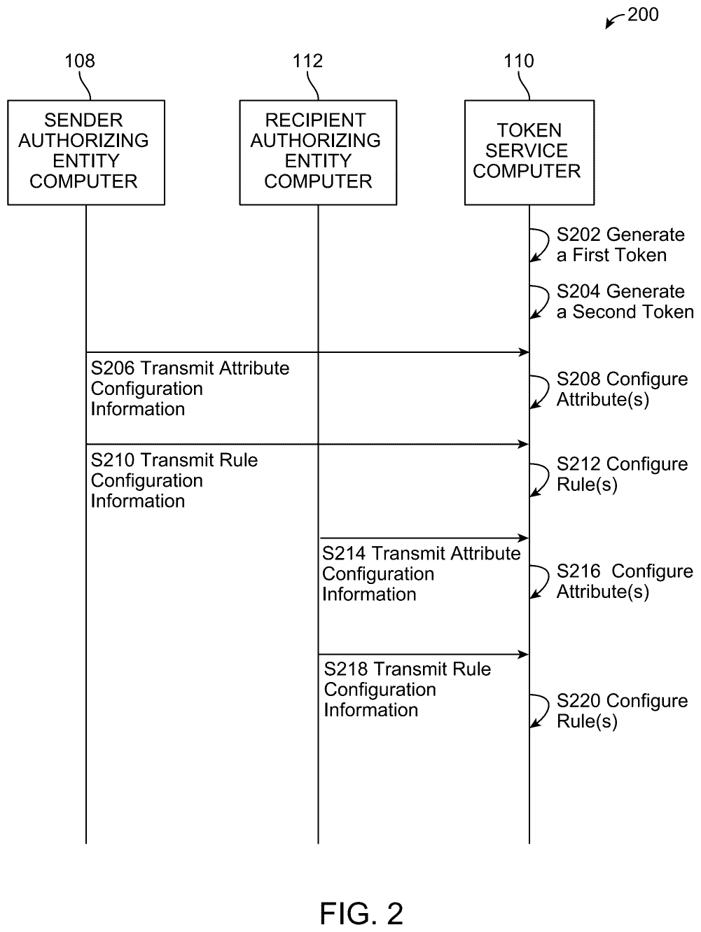

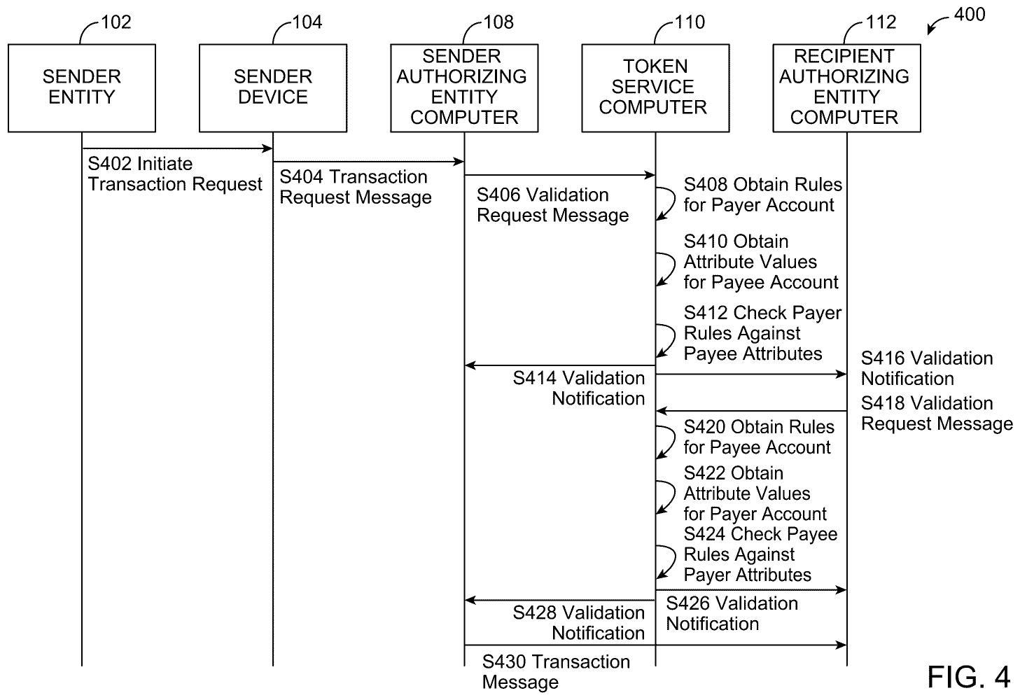

The processing depicted in FIGS. 2 and 4 and any other FIGS. may be implemented in software (e.g., code, instructions, program) executed by one or more processing units (e.g., processors, cores) of the respective systems, using hardware, or combinations thereof. The software may be stored on a non-transitory storage medium (e.g., on a memory device). The processing presented in FIGS. 2 and 4, other FIGS., and described herein is intended to be illustrative and non-limiting. Although FIGS. 2 and 4, and other FIGS, depict the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIGS. 2 and 4, and other FIGS. may include a greater number or a lesser number of steps than those depicted in the respective FIGS.

FIG. 2 is a flow diagram 200 for configuring attributes and transaction rules associated with tokens, according to certain embodiments. The flow diagram illustrates a system (e.g., system 100) that includes a sender authorizing entity computer 108 (e.g., the sender authorizing entity computer 108 described above), a recipient authorizing entity computer 112 (e.g., the recipient authorizing entity computer 112 described above), and a token service computer 110 (e.g., the token service computer 110 described above).

The token service computer 110 may store and manage tokens, transaction rules, attributes, and/or attribute values. Each token may be associated with an account and each account may be associated with one or more tokens. As described above, the token may be a sender token (e.g., a sender token for an account associated with the sender authorizing entity computer 108) or a recipient token (e.g., a recipient token for an account associated with the recipient authorizing entity computer 112).

A token may be associated with a set of one or more transaction rules. A transaction rule may be used to determine whether to enable a transaction to occur. The transaction rule may include criteria to be satisfied by one or more attributes of a counterparty (e.g., another account) and/or transaction attributes/data. In certain embodiments, after a token is generated one or more transaction rules may be associated with the token. The transaction rules associated with the token may be based on the account associated with the token. The transaction rules may be predetermined, and/or configurable.

The token may be associated with a set of one or more attributes. An attribute may include a field that an attribute value can be assigned to. The attribute may be an account attribute. An account attribute may be an attribute associated with the account and is not specific to a transaction. The account attribute may be stored by the token service computer 110 and/or received from an issuer. The account attribute may persist between multiple transactions. An example of an account attribute may include an account type, a time in good standing, a transaction frequency/velocity, and/or an account country, etc.

The attribute may be a transaction attribute. The transaction attribute may be associated with the token when the token is used to conduct a transaction. Information about the transaction may be represented by one or more transaction attributes. The transaction attribute(s) may be determined on a per-transaction basis. An example of a transaction attribute may include a transaction content (e.g., amount, value, items), a transaction location, and/or a transaction type, etc.

In certain embodiments, after a token is generated one or more attributes may be associated with the token. The attributes may include an attribute value that is unassigned or set to predetermined/default attribute value. The attribute value may be configurable (e.g., at step S204, at step S212). In certain embodiments, the attributes that are associated with the token can be configured.

In certain embodiments, after a token is generated, the attribute and/or the attribute value may be assigned based on information associated with the account associated with (e.g., represented by) the token or based on information associated with a funds transfer. An attribute may be associated with the token at a first time and/or the attribute can be disassociated with the token at a second time.

In certain embodiments, the attribute value may be indicated to be a private attribute. A private attribute may not be shared with a counter party. In certain embodiments, an authorizing entity computer can configure whether an attribute is indicated to be private.

At step S202, a token service computer 110 may generate a first token, such as the sender token. The sender token may be generated in response to a request made by the sender authorizing entity computer 108 for an account (e.g., sender account) issued by the sender authorizing entity computer 108. The sender token may represent first account information (e.g., a PAN) associated with the sender account managed by the sender authorizing entity computer 108. In certain embodiments, the sender token may be transmitted to the sender authorizing entity computer 108 and/or a sender device (e.g., sender device 104 described above). The sender token may be associated with a first set of one or more transaction rules. In some embodiments, the sender token may also be associated with a first set of one or more attributes.

At step S204, a token service computer 110 may generate a second token, such as the recipient token. The recipient token may be generated in response to a request made by the recipient authorizing entity computer 112 for an account (e.g., a recipient account) managed by the recipient authorizing entity computer 112. The recipient token may represent second account information (e.g., a PAN) associated with the recipient account managed by the recipient authorizing entity computer 112. In some embodiments, the recipient token may be transmitted to the recipient authorizing entity computer 112 and or a recipient device (e.g., recipient device 114 described above). The recipient token may be associated with a second set of one or more attributes. In some embodiments, the recipient token may also be associated with a second set of one or more transaction rules.

At step S206, the sender authorizing entity computer 108 may transmit first attribute configuration information to the token service computer 110. In certain embodiments, the sender device and/or an issuer of the sender account may transmit the first attribute configuration information to the token service computer 110. The first attribute configuration information may indicate an attribute to include in the first set of attributes (e.g., to associate with the sender token), an attribute to remove from the first set of attributes (e.g., to disassociate with the sender token), an attribute value to include in the first set of attribute values (e.g., to assign to a respective attribute included in the first set of attributes), an attribute value to remove from the first set of attribute values, and/or an attribute value to indicate as a private attribute. The first attribute configuration information may indicate a first attribute value to be associated with a first attribute included in the first set of attributes.

The sender authorizing entity computer 108 may transmit the first attribute configuration information to the token service computer 110 periodically to update the attributes associated with the sender token. Updating the attributes associated with a token and/or account can enable up to date account insights to be shared with other entities (e.g., the recipient authorizing entity computer 112). The first attribute configuration information transmitted to the token service computer 110 may be for a specified token or may be for one or more (e.g., all) tokens associated with (e.g., representing) accounts associated with the sender authorizing entity computer 108.

In certain embodiments, the token service computer 110 may process information associated with the sender token to generate the first attribute configuration information. For example, the token service computer may monitor how many times the token has been used to conduct a transaction over a period of time and determine a transaction velocity account attribute to include in the first set of attributes.

At step S208, the token service computer 110, based on the first attribute configuration information received from the sender authorizing entity computer 108, may configure the first set of attributes associated with the sender token, the attribute values associated with the first set of attributes, and the privacy of attribute levels based on the first attribute configuration information received from the sender authorizing entity computer 108. As an example, the token service computer 110 may assign a first attribute value to a first attribute associated with the sender token. In certain embodiments, the sender token may be stored by the sender authorizing entity computer 108 and/or the sender device.

At step S210, the sender authorizing entity computer 108 may transmit first rule configuration information to the token service computer 110. In certain embodiments, an issuer of the sender account may transmit first rule configuration information to the token service computer 110. The first rule configuration information may indicate a rule to include or not include in the first set of rules. The rule may indicate one or more attributes (e.g., account attributes and/or transaction attributes) associated with a counter party token and/or a transaction to check against the rule to determine/validate if a transaction may be conducted. In certain embodiments, a portion of the first rule configuration information may be transmitted from the sender device or based on information received from the sender device.

The sender authorizing entity computer 108 may transmit the first rule configuration information to the token service computer 110 periodically to update the first set of rules associated with the sender token. Updating the transaction rules can enable the transaction rules associated with a token and/or account to be changed over time. The first rule configuration information transmitted to the token service computer 110 may be for a specified token or may be for one or more (e.g., all) tokens associated with (e.g., representing) accounts associated with the sender authorizing entity computer 108.

At step S212, the token service computer 110, based on the first rule configuration information received from the sender authorizing entity computer 108, may configure the first set of rules associated with the sender token. As an example, the token service computer 110 may assign a transaction rule to the sender token.

At step S214, the recipient authorizing entity computer 112 may transmit second attribute configuration information to the token service computer 110. In certain embodiments, the recipient device or an issuer of the recipient account may transmit the second attribute configuration information to the token service computer 110. The second attribute configuration information may indicate an attribute to include in the second set of attributes (e.g., to associate with the recipient token), an attribute to remove from the second set of attributes (e.g., to disassociate with the recipient token), an attribute value to include in the second set of attribute values (e.g., to assign to a respective attribute included in the second set of attributes), and/or an attribute value to indicate as a private attribute. The second attribute configuration information may indicate an attribute value to be associated with an attribute included in the second set of attributes.

The recipient authorizing entity computer 112 may transmit the second attribute configuration information to the token service computer 110 periodically to update the attributes associated with the recipient token. Updating the attributes can enable up to date account insights to be shared with other entities (e.g., the sender authorizing entity computer 108). The second attribute configuration information transmitted to the token service computer 110 may be for a specified token or may be for one or more (e.g., all) tokens associated with (e.g., representing) accounts associated with the recipient authorizing entity computer 112.

At step S216, the token service computer 110, based on the second attribute configuration information received from the recipient authorizing entity computer 112, may configure the second set of attributes associated with the recipient token, the attribute values associated with attributes, and the privacy of attribute levels based on the second attribute configuration information received from the recipient authorizing entity computer 112. As an example, the token service computer 110 may assigned a second attribute value to a second attribute associated with the recipient token.

In certain embodiments, the recipient token may be stored by the recipient authorizing entity computer 112 and/or the recipient device.

At step S218, the recipient authorizing entity computer 112 may transmit second rule configuration information to the token service computer 110. In certain embodiments, the recipient device or an issuer of the recipient account may transmit the second rule configuration information to the token service computer 110. The second rule configuration information may indicate a rule to include or not include in the second set of transaction rules. The rule may indicate one or more attributes (e.g., account attributes and/or transaction attributes) associated with a counter party token and/or a transaction to check against the rule to determine/validate if a transaction may be conducted. In certain embodiments, the second rule configuration information may be transmitted from the recipient device or based on information received from the recipient device.

The recipient authorizing entity computer 112 may transmit the second rule configuration information to the token service computer 110 periodically to update the second set of rules associated with the recipient token. Updating the transaction rules can enable the transaction rules associated with a token and/or account to be changed over time. The second rule configuration information transmitted to the token service computer 110 may be for a specified token or may be for one or more (e.g., all) tokens associated with (e.g., representing) accounts associated with the recipient authorizing entity computer 112.

At step S220, the token service computer 110, based on the second rule configuration information received from the recipient authorizing entity computer 112, may configure the second set of rules associated with the recipient token. As an example, the token service computer 110 may assign a transaction rule to the recipient token.

As an example of how the generated tokens may be used, during a funds transfer operation, the recipient device may provide the recipient token to the sender device and the sender device may initiate a funds transfer request from the sender account associated with the sender token to the recipient account associated with the recipient token.

In certain embodiments, the sender authorizing entity computer 108 may also be the recipient authorizing entity computer 112 (e.g., the same entity may have issued the recipient account and the sender account). The sender authorizing entity computer 108 may manage accounts with information represented by tokens managed by the token service computer 110. The tokens representing an account managed by the sender authorizing entity computer 108 (e.g., sender account) may be associated with the same and/or different attributes and/or transaction rules as associated with tokens representing an account managed by the recipient authorizing entity computer 112 (e.g., recipient account). In certain embodiments, the sender authorizing entity computer 108 and/or the recipient authorizing entity computer 112 may receive a portion of the attribute settings and/or the rules from a user device (e.g., sender device, recipient device).

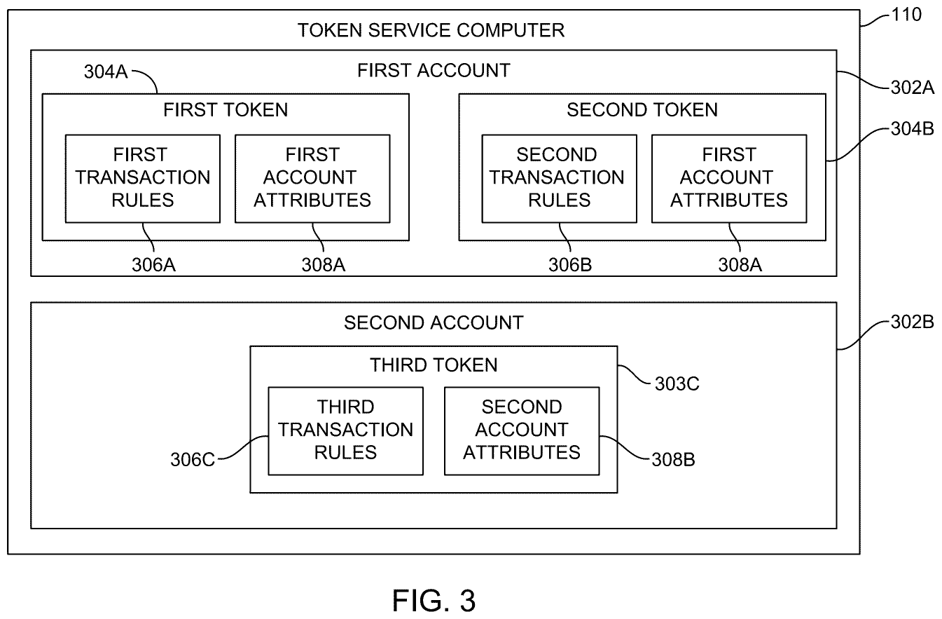

FIG. 3 illustrates an exemplary relationship between accounts, tokens, transaction rules, and account attributes, according to certain embodiments. FIG. 3 illustrates a token service computer 110 (e.g., the token service computer 110 described above). The token service computer 110 may manage a set of zero or more tokens associated with a set of zero or more accounts.

The first account 302A may be associated with one or more tokens such as a first token 304A and a second token 304B (e.g., C2B token(s), P2P token(s), Fintech1 token(s), B2C token(s), B2B token(s), C2B-Request for Payment (RfP) token(s), digital wallet token(s), open banking token(s), etc.). A token may be specific for a type of transaction. For example, the first token 304A for the first account 302A may be used to transfer funds to a corporate account and the second token 304B for the first account 302A may be used to transfer funds to a personal account. The first account 302A may be associated with a fourth token that is a token used when the first account 302A is receiving a transaction value and the fourth token may be a different token than what is used when the first account 302A is sending a transaction value.

The token service computer 110 may have generated the first token 304A and the second token 304B. The first token 304A may be associated with first transaction rules 306A that may include a first set of transaction rules. The first token 304A may be associated with first account attributes 308A that may include a set of account attributes. The first account attributes 308A may be associated with the first token 304A based on the first account 302A. The first account attributes 308A may be associated with one or more tokens that are associated with the first account 302A. The first account attributes 308A or a portion thereof may be common among multiple tokens associated with the first account 302A. For example, at least a portion of the first account attributes 308A may also be associated with the second token 304B. The second token 304B may be associated with second transaction rules 306B. The second transaction rules 306B may be the same, partially the same, or different rules from the first transaction rules 306A. The first account 302A may be associated with a first authorizing entity computer (e.g., a sender authorizing entity computer, a recipient authorizing entity computer).

In some embodiments, some account attributes are not associated with multiple tokens and instead some tokens associated with an account may include attributes that are not associated with another token that is associated with the account.

Transaction attributes may be determined after a transaction has been initiated and may be transmitted to the token service computer 110 or another device that has access to the transaction rules (e.g., an authorizing entity computer) so that the transaction attributes may be checked against the transaction rules.

The token service computer may store a third token 303C that may be associated with a second account 302B that is different than the first account 302A. The second account 302B may be managed by the same or a different authorizing entity computer than the first account 302A. The third token 303C may be associated with third transaction rules 306C that includes a second set of transaction rules. The third transaction rules 306C may be the same, partially different, or different from the first transaction rules 306A and/or the second transaction rules 306B. The third token may be associated with second account attributes 308B that include a set of account attributes.

Account attributes of one token (e.g., the first token 304A) may be checked against the rules of another token (e.g., the third token 303C) before the transaction is initiated.

In certain embodiments, transaction rules for recipient accounts may be less restrictive than transaction rules for sender accounts. There may be a single sender token needed as opposed to different recipient tokens for different use cases as the rules may not be different unlike a sender use case where the risk is on the sender account as the resources move out of the sender account instead of coming into it. In other embodiments, the recipient account may also be associated with multiple tokens, each configured for a particular type of transaction (e.g., a token may be used to receive funds from a corporate account and a different token may be used to receive funds from a personal account).

Any of the first token 304A, the second token 304B, and the third token 304C may be sender tokens and/or recipient tokens. For example, in certain embodiments, the first token 304A can be used to determine an account to send to and/or receive from and the first token 304A may be capable of being used to send to another account or receive from another account in any given transaction. In certain embodiments, a token may be configured to be a sender token and may not be used as a recipient token because the token is associated with a set of transaction rules and is not associated with a set of account attributes. In certain embodiments, a token may be configured to be a recipient token and may not be used as a sender token because the token is associated with a set of account attributes and is not associated with a set of transaction rules. Other embodiments are also considered. For example, a sender token may be associated with a set of account attributes and not associated with a set of transaction rules, the attributes of the sender token may be used to check against a set of rules associated with a recipient token during a transaction. In an example, a recipient token may be associated with a set of transaction rules and not be associated with a set of account attributes, the set transaction rules may be compared with a set of attributes associated with the sender token.

FIG. 4 is a flow diagram 400 illustrating validation of transaction attributes, according to certain embodiments. Flow diagram 400 illustrates a system (e.g., system 100 described above). The system includes a sender entity 102 (e.g., sender entity 102 described above), a sender device 104 (e.g., sender device 104 described above), a sender authorizing entity computer 108 (e.g., sender authorizing entity computer 108 described above), a token service computer 110 (e.g., token service computer 110 described above), and a recipient authorizing entity computer 112 (e.g., recipient authorizing entity computer 112 described above).

At step S402, the sender entity 102 may initiate a transaction request using the sender device 104. The sender entity 102 may be an owner of a sender account managed by the sender authorizing entity computer 108. The transaction request may indicate a resource (e.g., funds, cryptocurrency, document, asset) transfer from the sender account to a recipient account. The recipient account may be managed by the recipient authorizing entity computer 112. The sender device 104 may receive input (e.g., user input via a user interface) from the sender entity 102 (e.g., a user) to initiate the transaction.

At step S404, the sender device 104 may transmit a transaction request message to the sender authorizing entity computer 108 (e.g., sender). The transaction request message may include transaction data such as a transaction content (e.g., amount, value, items), a location, a time of day, a recipient account associated with the recipient authorizing entity computer 112 (e.g., recipient), and/or other information capable of being obtained by the sender device 104, etc. The sender authorizing entity computer 108 may receive the transaction request message from the sender device 104.

At step S406, the sender authorizing entity computer 108 may transmit a first validation request message to the token service computer 110. The token service computer 110 may manage one or more tokens associated with the sender account and/or another account (e.g., an account managed by the recipient authorizing entity computer 112). The tokens may be associated with one or more transaction rules, and/or one or more attributes (e.g., account attributes, transaction attributes) and corresponding attribute values.

The first validation request message may include a sender token associated with the sender entity 102, sender device 104, sender account, and/or sender authorizing entity computer 108. The first validation request message may include an identifier (e.g., a recipient token, recipient account identifier, PAN) for a recipient account associated with the recipient entity, the recipient device or the recipient authorizing entity computer 112. The first validation request message may include a request to check an attribute value associated with an attribute of the recipient token against one or more transaction rules associated with the sender token.

In some embodiments, the first validation request message may include information that enables the token service computer 110 to look up the sender token or the recipient token. The first validation request message may include information that enables the token service computer 110 to look up attribute values associated with the recipient token associated with the recipient authorizing entity computer 112 (e.g., recipient bank).

At step S408, the token service computer 110 may obtain transaction rules for the sender token representing the sender account associated with the sender authorizing entity computer 108 (e.g., sender). The token service computer 110 may obtain the transaction rules for the sender token based on the first validation request message received by the token service computer 110. The transaction rules may be obtained from memory of the token service computer 110. In certain embodiments, the transaction rules are obtained from the sender authorizing entity computer 108. The transaction rules may be obtained based on the sender token and/or an identifier of the sender account.

At step S410, the token service computer 110 may obtain attributes and/or attribute values for the recipient token representing the recipient account associated with the recipient authorizing entity computer 112 (e.g., recipient). The token service computer 110 may obtain the attributes for the recipient token based on the first validation request message received by the token service computer 110. The attributes and/or attribute values may be obtained from memory of the token service computer 110. In certain embodiments, the attributes are obtained from the recipient authorizing entity computer 112. The attributes may be obtained based on the recipient token and/or an identifier of the recipient account.

At step S412, the token service computer 110 may check one or more attributes associated with the recipient token against one or more transaction rules associated with the sender token. The token service computer 110 may determine/check whether the attribute values for the recipient token (or account) satisfy the transaction rules set for the sender token (or account). In certain embodiments, the token service computer 110 may determine/check whether the transaction data satisfies one or more rules associated with the sender token.

In certain embodiments, if the transaction rules associated with the sender token were not satisfied by the attribute values associated with the recipient token, further steps are not performed.

At step S414, responsive to the transaction rules associated with the sender token being checked against the transaction attribute value (e.g., determining whether criteria defined by the transaction rules associated with the sender token are met by the attribute values associated with the recipient token) at step S412, a first validation notification (indicating successful or unsuccessful sender account transaction rule validation) may be transmitted to the sender authorizing entity computer 108.

In certain embodiments, the first validation notification transmitted to the sender authorizing entity computer 108 includes one or more attributes, attribute values, and/or rules associated with the recipient token. For example, an attribute value (e.g., an account attribute value such as time in good standing) associated with the recipient token that may have been checked against a transaction rule associated with the sender token may be transmitted to the sender authorizing entity computer 108 to improve transparency and/or trust of the rule application performed by the token service computer 110 and/or of the recipient account.

At step S416, responsive to the transaction rules associated with the sender token being checked against the transaction attribute value (e.g., determining whether criteria defined by the transaction rules associated with the sender token are met by the attribute values associated with the recipient token) at step S412, a second validation notification (indicating successful or unsuccessful sender account transaction rule validation) may be transmitted to the recipient authorizing entity computer 112.

In certain embodiments, the second validation notification transmitted to the recipient authorizing entity computer 112 includes one or more attributes, attribute values, and/or rules associated with the sender token. For example, an attribute value (e.g., a sender account attribute value such as time in good standing) associated with the sender token may be transmitted to the recipient authorizing entity computer 112 to improve transparency and/or trust of the rule application performed by the token service computer 110 and/or of the sender account. For example, a transaction rule associated with the sender token may be transmitted to the recipient authorizing entity computer 112 to improve transparency and/or trust of the rule application performed by the token service computer 110 and/or of the sender account.

Steps S418-430 may be performed if the second validation notification transmitted to the recipient authorizing entity computer 112 indicates a successful validation of the transaction rules associated with the sender token.

At step S418, the recipient authorizing entity computer 112 may transmit a second validation request message to the token service computer 110. The second validation request message may include the sender token associated with the sender entity 102, sender device 104, sender account, and/or sender authorizing entity computer 108. The second validation request message may include an identifier (e.g., the recipient token, PAN) for the recipient account associated with the recipient entity, the recipient device or the recipient authorizing entity computer 112. The second validation request message may include a request to check an attribute value associated with an attribute of the sender token against one or more transaction rules associated with the recipient token.

In some embodiments, the second validation request message may include information that enables the token service computer 110 to look up the recipient token or the sender token. The second validation request message may include information that enables the token service computer 110 to look up attribute values associated with the sender token associated with the sender authorizing entity computer 108 (e.g., sender bank).

At step S420, the token service computer 110 may obtain transaction rules for the recipient token representing the recipient account associated with the recipient authorizing entity computer 112 (e.g., recipient). The token service computer 110 may obtain the transaction rules for the recipient token based on the second validation request message received by the token service computer 110. The recipient token transaction rules may be obtained from memory of the token service computer 110. In certain embodiments, the recipient token transaction rules are obtained from the recipient authorizing entity computer 112. The recipient token transaction rules may be obtained based on the recipient token and/or an identifier of the recipient account.

At step S422, the token service computer 110 may obtain attributes and/or attribute values for the sender token representing the sender account associated with the sender authorizing entity computer 108 (e.g., sender). The token service computer 110 may obtain the attributes for the sender token based on the second validation request message received by the token service computer 110. The attributes and/or attribute values may be obtained from memory of the token service computer 110. In certain embodiments, the attributes are obtained from the sender authorizing entity computer 108. The attributes may be obtained based on the sender token and/or an identifier of the sender account.

At step S424, the token service computer 110 may check one or more attributes associated with the sender token against one or more transaction rules associated with the recipient token. The token service computer 110 may determine/check whether the attribute values for the sender token (or account) satisfy the transaction rules set for the recipient token (or account). In certain embodiments, the token service computer 110 may determine/check whether the transaction data satisfies one or more rules associated with the recipient token.

In certain embodiments, if the transaction rules associated with the recipient token were not satisfied by the attribute values associated with the sender token, further steps are not performed.

At step S426, responsive to the transaction rules associated with the recipient token being checked against the transaction attribute value (e.g., determining whether criteria defined by the transaction rules associated with the recipient token are met by the attribute values associated with the sender token) at step S424, a third validation notification (indicating successful or unsuccessful recipient account transaction rule validation) may be transmitted to the recipient authorizing entity computer 112.

In certain embodiments, the third validation notification transmitted to the recipient authorizing entity computer 112 includes one or more attributes, attribute values, and/or rules associated with the sender token. For example, an attribute value (e.g., an account attribute value such as time in good standing) associated with the sender token that may have been checked against a transaction rule associated with the recipient token may be transmitted to the recipient authorizing entity computer 112 to improve transparency and/or trust of the rule application performed by the token service computer 110 and/or of the sender account.

At step S428, responsive to the transaction rules associated with the recipient token being checked against the transaction attribute value (e.g., determining whether criteria defined by the transaction rules associated with the recipient token are met by the attribute values associated with the sender token) at step S424, a fourth validation notification (indicating successful or unsuccessful recipient account transaction rule validation) may be transmitted to the sender authorizing entity computer 108.

In certain embodiments, the fourth validation notification transmitted to the sender authorizing entity computer 108 includes one or more attributes, attribute values, and/or rules associated with the recipient token. For example, an attribute value (e.g., a recipient account attribute value such as time in good standing) associated with the recipient token may be transmitted to the sender authorizing entity computer 108 to improve transparency and/or trust of the rule application performed by the token service computer 110 and/or of the recipient account. For example, a transaction rule associated with the recipient token may be transmitted to the sender authorizing entity computer 108 to improve transparency and/or trust of the rule application performed by the token service computer 110 and/or of the recipient account.

At step S430, if the rules associated with tokens of the sender account and the recipient account were satisfied, a transaction between the sender authorizing entity computer 108 and the recipient authorizing entity computer 112 may be performed. The transaction may be for a resource and may cause the resource to be transferred from the sender account of the sender authorizing entity computer 108 to the recipient account of the recipient authorizing entity computer 112.

As described above, in certain alternative embodiments, the processing may be performed in some different order. For example, step S430 may be performed before S410 where the attributes and/or attribute values for the recipient token representing the recipient account associated with the recipient authorizing entity computer 112 (e.g., recipient) are obtained. In an example, step S430 may be performed after checking transaction rules associated with the payer token against the attribute values associated with the recipient account and before checking transaction rules associated with the recipient token against the attribute values associated with the sender account.

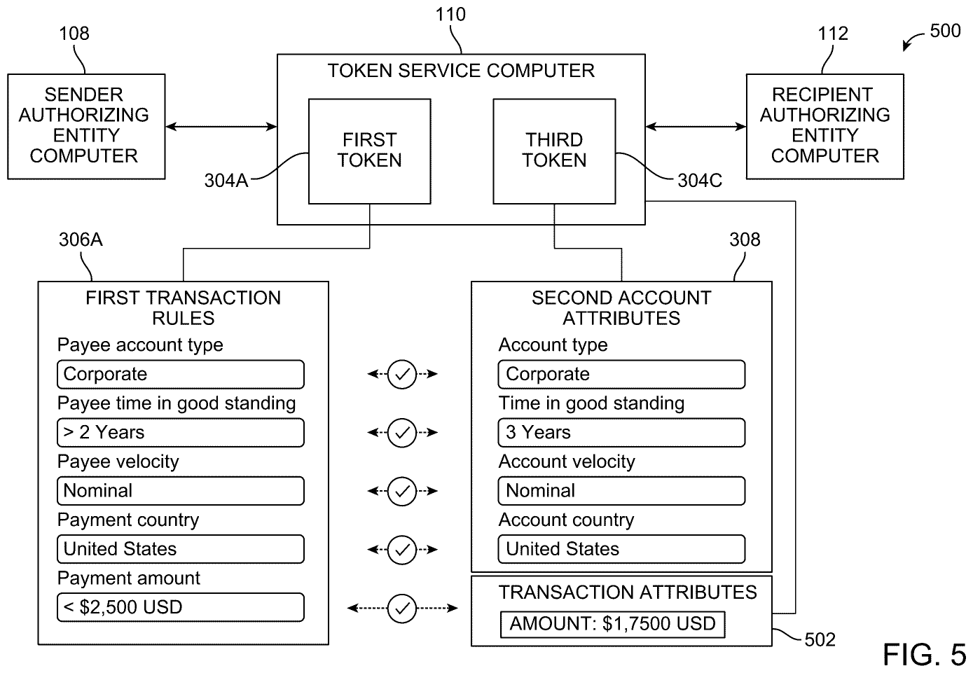

FIG. 5 illustrates an example system 500 determining that first transaction rules 306A are satisfied by second account attributes 308, according to certain embodiments. System 500 includes a sender authorizing entity computer 108 (e.g., sender authorizing entity computer 108 described above), a token service computer 110 (e.g., token service computer 110 described above), and a recipient authorizing entity computer 112 (e.g., recipient authorizing entity computer 112 described above). System 500 illustrates an example of how validation may be performed using attributes associated with a third token 304C (e.g., third token 304C described above) and transaction rules associated with a first token 304A (e.g., first token 304A described above).

The sender authorizing entity computer 108 may communicate with the token service computer 110 as described above (e.g., with respect to flow diagram 400). The recipient authorizing entity computer 112 may communicate with the token service computer 110 as described above (e.g., with respect to flow diagram 400). The token service computer 110 may manage and/or store a set of tokens. The tokens may be associated with one or accounts of one or more authorizing entity computers. The first token 304A may be associated with a sender account. The first token 304A may be associated with a set of first transaction rules 306A. The third token 304C may be associated with a recipient account. The third token 304C may be associated with a set of second account attributes 308B.

System 500 illustrates an embodiment where the token service computer 110 checks whether the first transaction rules 306A are satisfied by the second account attributes 308B. In the illustrated example, the first transaction rules 306A associated with the first token 304A that is associated with the sender account managed by the sender authorizing entity computer 108 indicate requirements to be satisfied by the third token 304C because the third token 304C is associated with the recipient account. For the sake of example, the first transaction rules 306A are illustrated to specifically require that the recipient account is in a corporate account type, the recipient account time in good standing is greater than two years, the recipient account velocity is nominal, the recipient account is located in or issued in the United States, and transaction value (e.g., amount) indicated by a set of transaction attributes 502 must be less than $2,500. The transaction attributes 502 may have been received from a recipient device, a sender device, the sender authorizing entity computer 108, the recipient authorizing entity computer 112, and/or the token service computer 110. The transaction attributes 502 may be based on transaction information/data on a per-transaction basis. As described above, the first transaction rules 306A may have been configured by the sender authorizing entity computer 108.

The token service computer 110 may compare the second account attributes 308B and the attribute values of the third token 304C against the first transaction rules 306A. In some embodiments, the transaction may be authorized only if all the first transaction rules 306A are checked and satisfied. In other embodiments, the transaction may be authorized when a predetermined percentage of the first transaction rules 306A are checked and satisfied by the second account attributes 308B, or when a weighted average of the satisfied rules is above a threshold.

In the illustrated example, all of the first transaction rules 306A are satisfied by the attributes (e.g., second account attributes 308B and transaction attributes 502) associated with the third token 304C. Responsive to the first transaction rules 306A being satisfied, the transaction may be allowed to proceed and/or rules associated with the third token 304C may be checked against attributes associated with the first token 304A before determining whether the transaction may be allowed to proceed (e.g., as described above with respect to flow diagram 400).

In certain embodiments, one or more other factors used by the sender authorizing entity computer 108 and/or recipient authorizing entity computer 112 may result in a transaction not being performed even if the validation of the transaction rules associated with the first token 304A and/or the third token 304C is successful. In certain embodiments, the sender authorizing entity computer 108 may use the outcome of the validation check against the first transaction rules 306A to adjust the first transaction rules 306A (the recipient authorizing entity computer 112 may also be capable of adjusting rules associated with the third token 304C based on a validation result).

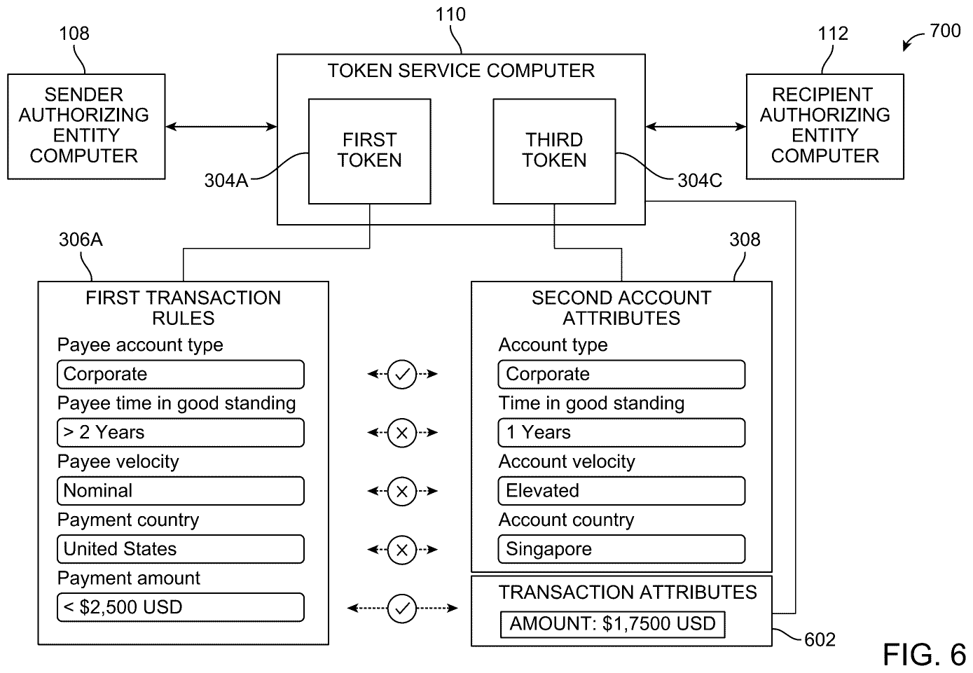

FIG. 6 illustrates an example system 600 determining that second account attributes 308 fail to satisfy first transaction rules 306A, according to certain embodiments. System 600 may be the system 100 and/or the system 500 described above. System 600 includes a sender authorizing entity computer 108 (e.g., sender authorizing entity computer 108 described above), a token service computer 110 (e.g., token service computer 110 described above), and a recipient authorizing entity computer 112 (e.g., recipient authorizing entity computer 112 described above). System 600 illustrates an example of how validation may be performed using attributes associated with a third token 304C (e.g., third token 304C described above) and transaction rules associated with a first token 304A (e.g., first token 304A described above).

System 600 illustrates an embodiment where the token service computer 110 checks whether the first transaction rules 306A are satisfied by the second account attributes 308B. In the illustrated example, the first transaction rules 306A associated with the first token 304A that is associated with the sender account managed by the sender authorizing entity computer 108 indicate requirements to be satisfied by the third token 304C because the third token 304C is associated with the recipient account. For the sake of example, the first transaction rules 306A are illustrated to specifically require that the recipient account is in a corporate account type, the recipient account time in good standing is greater than two years, the recipient account velocity is nominal, the recipient account is located in or issued in the United States, and transaction amount indicated by a set of transaction attributes 502 must be less than $2,500. The transaction attributes 502 may have been received from a recipient device, a sender device, the sender authorizing entity computer 108, the recipient authorizing entity computer 112, and/or the token service computer 110. The transaction attributes 502 may be based on transaction information/data on a per-transaction basis. As described above, the first transaction rules 306A may have been configured by the sender authorizing entity computer 108.

The token service computer 110 may compare the second account attributes 308B and the attribute values of the third token 304C against the first transaction rules 306A. In the illustrated example, some, but not all, of the first transaction rules 306A are satisfied by the attributes (e.g., second account attributes 308B and transaction attributes 502) associated with the third token 304C. Responsive to the first transaction rules 306A being unsatisfied, the transaction may not be allowed to proceed (e.g., as described above with respect to flow diagram 400). In certain embodiments, responsive to the first transaction rules 306A being unsatisfied, the sender authorizing computer may still determine to continue with the transaction (e.g., after requesting and obtaining permission from the account owner).

Although system 500 and 600 illustrate rules associated with a sender token being checked against attributes and attribute values of a recipient token, one of ordinary skill in the art with the benefit of the present disclosure would recognize that similar processing may be performed, additionally or alternatively, with respect to rules associated with a recipient token before, after, or in parallel to the rules of the sender token being checked.

The techniques (e.g., use of tokens, transaction rules, attributes, etc.) described herein can be used to conduct transactions involving resources. The resources may include services and/or items. The resources may be digital and/or physical. For example, embodiments described herein may be used to conduct a data transfer between a sender and a recipient. The sender and the recipient may be associated with respective tokens. Each of the tokens can be configured to be associated with a set of transaction rules and/or a set of attributes (e.g., account attributes, transaction attributes). One or more attributes associated with one token can be compared against one or more attributes associated with the other token to determine if the data transfer should proceed. The tokens can enable the parties to the data transfer to remain anonymous to the other. The transaction rules and/or attributes associated with the token(s) can enable the parties to know certain information about the counter party and the information may be known such that the information is still privacy preserving. For example, a token rule may enable a data transfer to proceed if the counterparty is located in a first country. The exact location of the counterparty may be kept private as well as the identity of the counterparty.

Embodiments described herein provide for various benefits. By leveraging attribute-based rule evaluation (e.g., comparing transaction rules of one token against attributes associated with another token), resulting improvements can include improvements in transactional integrity, confidentiality, and/or regulatory compliance. Embodiments can also benefit from enhanced trust among account owners.

Trust among authorizing entities, issuers, and account holders can be improved because embodiments may ensure transactions are subject to an automated, objective, and/or pre-defined vetting processes. Validating, by a party, that a counter party (e.g., a recipient meets all necessary criteria indicated by a set of account attributes such as identity verification, regulatory compliance, or eligibility), the party can be assured that transactions are conducted with intended, appropriate, and/or authorized parties, thereby reducing the risk of errors, fraud, and/or unauthorized access to resources.

Additionally, embodiments can improve confidentiality and data security by permitting granular control over what information is shared and under what circumstances. Transaction rules can be used and specifically configured to ensure data (e.g., sensitive data) is only exchanged when a counter party's (e.g., a recipient) account attributes (e.g., security clearances, certifications, and/or membership in a trusted network, etc.) match the other part's (e.g., the sender's) confidentiality requirements (e.g., the recipient's account attributes satisfy the set of transaction rules associated with the sender). As a result, unnecessary and/or unintentional data exposure can be minimized and/or privacy laws and regulations can be complied with.

Embodiments can also enable adaptable compliance with changing requirements. The transaction rules can be updated centrally (e.g., by a token service computer) and applied automatically to transactions, ensuring that new legal and/or entity requirements are immediately reflected in every transaction, without the need for manual intervention, improving scalability, reducing operational burdens, and reducing the risk of non-compliance.

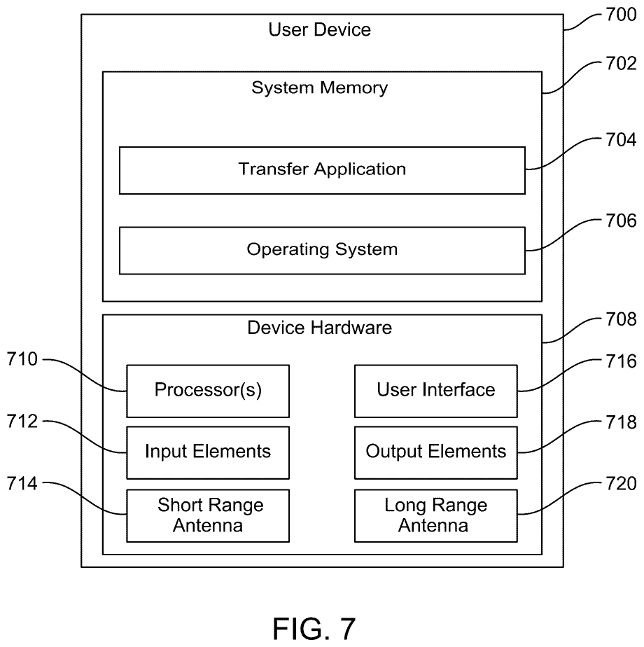

FIG. 7 illustrates a simplified block diagram of a user device 700 that may be used with embodiments of the present disclosure. The user device 700 may be a sender device (e.g., sender device 104 described above) or recipient device (e.g., recipient device 114 described above). The user device 700 can be a mobile device (e.g., mobile phone, smart watch, tablet, etc.) with a transfer application (e.g., 704). User device 700 can be capable of performing the techniques described herein. The user device 700 may include device hardware 708 coupled to a system memory 702.

Device hardware 708 may include a processor 710, input elements 712, a short range antenna 714, a user interface 716, output elements 518, and a long range antenna 720. Examples of input elements 712 may include microphones, keypads, touchscreens, sensors, and/or cameras, etc. Examples of output elements 718 may include speakers, display screens, tactile devices, and/or light emitting diodes (LEDs), etc. The processor 710 can be implemented as one or more integrated circuits (e.g., one or more single core or multicore microprocessors and/or microcontrollers), and is used to control the operation of user device 700. Processor 710 can execute a variety of programs in response to program code or computer-readable code stored in the system memory 702, and can maintain multiple concurrently executing programs or processes.

The long range antenna 720 may include one or more radio frequency (RF) transceivers and/or connectors that can be used by user device 700 to communicate with other devices and/or to connect with external networks. The input elements 712 and output elements 718 allow a user to interact with and invoke the functionalities of user device 700. The short range antenna 714 may be configured to communicate with external devices through a short range communication medium (e.g., using Bluetooth, Wi-Fi, infrared, NFC, etc.). The long range antenna 720 may be configured to communicate with a remote base station and a remote cellular or data network, over the air.

The system memory 702 can be implemented using any combination of any number of non-volatile memories (e.g., flash memory) and volatile memories (e.g., DRAM, SRAM), or any other non-transitory storage medium, or a combination thereof media. The system memory 702 may store computer code, executable by the processor 710, for performing any of the functions described herein. For example, the system memory 702 may comprise a computer readable medium comprising code, executable by the processor 710, for implementing a method as described herein.

For example, the method may include transmitting attribute configuration information to a token service computer, transmitting rule configuration information to the token service computer, obtaining a token from an authorizing entity computer, and/or receiving a validation notification from the token service computer.

The system memory 702 may also store a transfer application 704 and/or an operating system 706. The transfer application 704 may include instructions or code implementing a transfer application 704 for initiating a transfer of funds to an account identifier associated with a recipient user device. The transfer application 704 may also include code, executable by the processor 710, for obtaining a funds transfer amount and the account identifier associated with the recipient, providing the funds transfer amount and recipient account identifier to a first authorizing entity computer, and/or forwarding a push transfer message to a processing network computer.

The transfer application 704 may also include code, executable by the processor 710, for obtaining a funds transfer amount (e.g., a transaction value) and the account identifier (e.g., a PAN, a token) associated with the recipient entity, providing the funds transfer amount and recipient account identifier to a first authorizing entity computer, and/or forwarding a pull transfer message to a processing network computer.

The transfer application 704 may also include code, executable by the processor 710, for transmitting a funds transfer amount and an account identifier (e.g., a PAN, a token) associated with a recipient to another transfer application of a second user device.

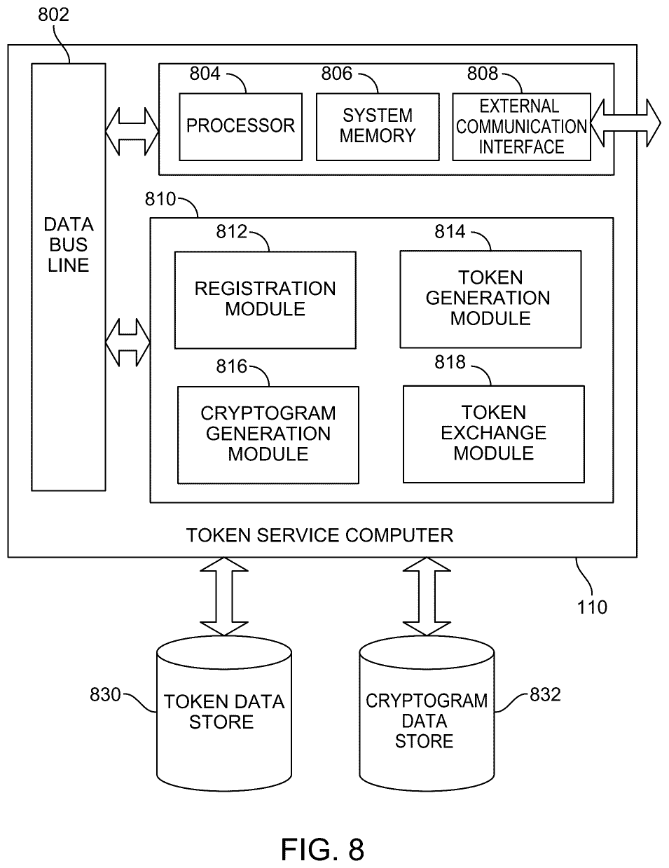

FIG. 8 illustrates a simplified block diagram of a token service computer 110 (e.g., token service computer 110 described above) that may be used with embodiments of the present disclosure.

The token service computer 110 may comprise a processor 804, which may be coupled to a system memory 806 and an external communication interface 808. A computer readable medium 810 may also be operatively coupled to the processor 804. Computer readable medium 810 may also comprise code for implementing the methods discussed herein.

The computer readable medium 810 may comprise a number of software modules including a registration module 812, a token generation module 814, a cryptogram generation module 816, and a token exchange module 818. Although these various modules are depicted as being internal to the token service computer 110, any number of these modules may instead be implemented as separate systems external to the token service computer 110.

The registration module 812 may comprise code which can cause the processor 804 to register a token requestor entity with a token data store 830 and to generate a token requestor identifier for the registered entity. Some non-limiting examples of the token requestor entities may include authorizing entities (e.g., issuers), resource providers (e.g., merchants, e-commerce merchants, transit authorities, etc.), directory server computers, processing network computers, transport computers (e.g., acquirers), user devices, or subcomponents and applications thereof.

The registration module 812 may be configured to cause the processor 804 to receive registration information such as an entity name, contact information, an entity type (e.g., user, directory server computer, resource provider, service provider, transaction processor, authorizing entity, transport entity, etc.), account attributes, account attribute values, transaction rules, and/or any other relevant information for registration processing. In some examples, registration module 812 may be configured to cause the processor 804 to provide one or more interfaces for collecting registration information. Such interfaces may be provided by the processor 804 and rendered via an application and/or website managed by the processor 804 as part of the functionality of registration module 812. In some embodiments, the registration module 812 may cause the processor 804 to validate the information and store the token requestor details in the token data store 830. The registration module 812 may also generate a token requestor ID after successful registration. In some embodiments, the token requestor ID may be a credential. However, other formats of the token requestor identifier are possible. The registration module 812 may further be configured to transmit the token requestor ID to the token requestor.

The token generation module 814 may be configured to cause the processor 804 to generate a token in response to a token request message from a token requestor (e.g., sender authorizing entity computer, recipient authorizing entity computer, recipient device, sender device, etc.). In one embodiment, the token generation module 814 may cause the processor 804 to receive a token request message (e.g., a message including a token requestor ID, an account number (e.g., PAN), an expiration date, a CVV2, attribute configuration information (e.g., described with respect to flow diagram 200), rule configuration information (e.g., described with respect to flow diagram 200), etc.). In some embodiments, the token generation module 814 may cause the processor 804 to validate the token requestor ID and generate a token (e.g., a token linked to a virtual account number for the PAN). In one embodiment, the token generation module 814 may cause the processor 804 to generate a token response message including the generated token, a set of attributes associated with the token, and/or a set of transaction rules associated with the token. The token data store 830 may be utilized by the processor 804 to maintain a correlation (e.g., a mapping) between a credential (e.g., an account number (e.g., a PAN)), a token requestor ID, and one or more tokens. In an embodiment, the token generation module 814 may determine if a predefined number of tokens already exist in the token data store 830 for the credential. The token generation module 814 may cause an association between the generated token and one or more transaction rules, one or more account attributes, and/or one or more account attribute values to be stored. The token generation module 814 may cause an association between the generated token and the account to be stored.

The cryptogram generation module 816 may be configured to cause the processor 804 to receive an authentication request message from a credential requestor (e.g., a resource provider computer). The cryptogram generation module 816 may be configured to cause the processor 804 to generate a token authentication cryptogram (e.g., a TAVV).

The token exchange module 818 may comprise code, executable by the processor 804, to cause the processor 804 to allow registered entities to request a credential (e.g., a PAN), a set of attributes, and/or a set of transaction rules associated with a given token. In one embodiment, token exchange module 818 may be configured to cause processor 804 to validate the credential/token mapping (e.g., a PAN to token mapping). Upon successful validation, the token exchange module 818 may be configured to cause processor 804 to retrieve the credential (e.g., the PAN) and provide it to the requesting entity.

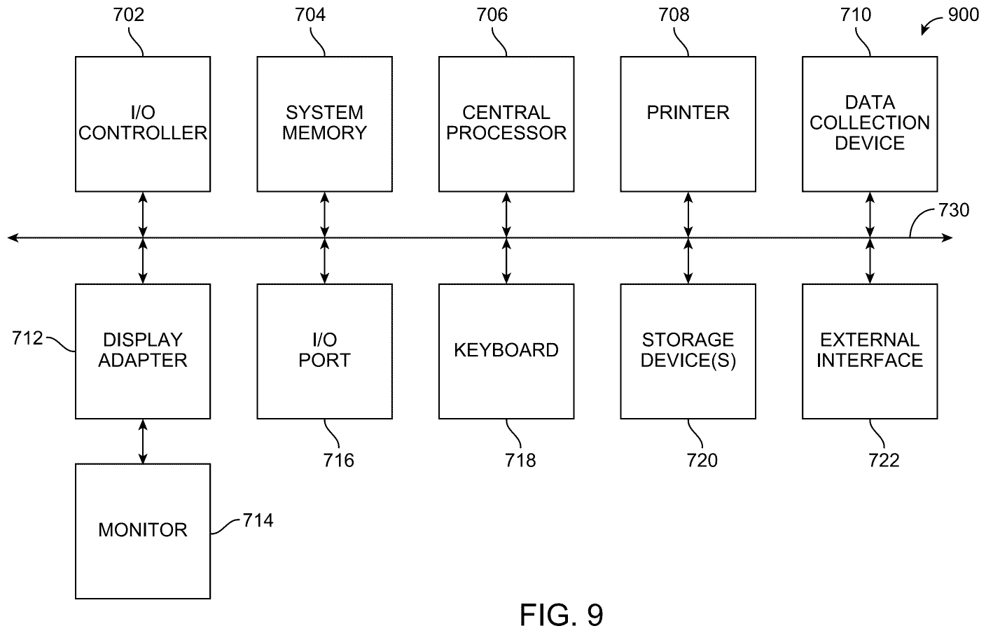

FIG. 9 illustrates a simplified block diagram of a computer system 900 that may be used with embodiments of the present disclosure. Any of the computer systems mentioned herein may utilize any suitable number of subsystems. Examples of such subsystems are shown by computer system 900. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 9 are interconnected via a system bus 930. Additional subsystems such as a printer 908, keyboard 918, storage device(s) 920, monitor 914 (e.g., a display screen, such as an LED), which is coupled to display adapter 912, and others are shown. Peripherals and input/output (I/O) devices, which couple to I/O controller 902, can be connected to the computer system by any number of means known in the art such as input/output (I/O) port 916 (e.g., USB, FireWire®). For example, I/O port 916 or external interface 922 (e.g., Ethernet, Wi-Fi, etc.) can be used to connect computer system 900 to a wide area network such as the Internet, a mouse input device, or a scanner. The interconnection via system bus 930 allows the central processor 906 to communicate with each subsystem and to control the execution of a plurality of instructions from system memory 904 or the storage device(s) 920 (e.g., a fixed disk, such as a hard drive, or optical disk), as well as the exchange of information between subsystems. The system memory 904 and/or the storage device(s) 920 may embody a computer readable medium. Another subsystem is a data collection device 910, such as a camera, microphone, accelerometer, and the like. Any of the data mentioned herein can be output from one component to another component and can be output to the user.

A computer system can include a plurality of the same components or subsystems, e.g., connected together by external interface 922, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components. In various embodiments, methods may involve various numbers of clients and/or servers, including at least 10, 20, 50, 100, 200, 500, 1,000, or 10,000 devices. Methods can include various numbers of communication messages between devices, including at least 100, 200, 500, 1,000, 10,000, 50,000, 100,000, 500,00, or one million communication messages. Such communications can involve at least 1 MB, 10 MB, 100 MB, 1 GB, 10 GB, or 100 GB of data.

Aspects of embodiments can be implemented in the form of control logic using hardware circuitry (e.g., an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. The computations can be performed in parallel by the different processing units and/or different processing threads of a single processing unit. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such devices. In addition, the order of operations may be re-arranged. A process can be terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor may be performed in real-time. The term “real-time” may refer to computing operations or processes that are completed within a certain time constraint. As examples, a time constraint may be 30 seconds, 1 minute, 10 minutes, 30 minutes, 1 hour, 4 hours, 1 day, or 7 days. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted as prior art. Where a conflict exists between the instant application and a reference provided herein, the instant application shall dominate.

What is claimed is:

1. A method performed by a token service computer, the method comprising:
generating a first token for a first account associated with a first authorizing entity computer, the first token associated with a first attribute;
generating a second token for a second account associated with a second authorizing entity computer;
assigning a first transaction rule to the second token;
assigning a first attribute value to the first attribute associated with the first token;
receiving a request to check the first attribute value of the first attribute against the first transaction rule; and
responsive to the first attribute value of the first attribute satisfying the first transaction rule:
transmitting a first validation message to the second authorizing entity computer.

2. The method of claim 1, further comprising:
assigning a second attribute value to a second attribute associated with the second token;
assigning a second transaction rule to the first token; and
wherein responsive to the first attribute value of the first attribute satisfying the first transaction rule:
checking the second attribute value of the second attribute against the second transaction rule; and
responsive to the second attribute value of the second attribute satisfying the second transaction rule:
transmitting a second validation message to the first authorizing entity computer.

3. The method of claim 2, further comprising:
responsive to the second attribute value of the second attribute satisfying the second transaction rule, performing a transaction between the first authorizing entity computer and the second authorizing entity computer.

4. The method of claim 2, wherein the second validation message includes the second attribute.

5. The method of claim 2, wherein at least one of the first attribute is included in a first set of one or more attributes or the second attribute is included in a second set of one or more attributes.

6. The method of claim 1, wherein the first transaction rule is included in a set of one or more transaction rules.

7. The method of claim 1, wherein the first attribute includes at least one of: a transaction attribute or an account attribute.

8. The method of claim 1, wherein the first transaction rule identifies a value to check against the first attribute.

9. The method of claim 1, wherein the first attribute is indicated as restricted from sharing with the second authorizing entity computer.

10. The method of claim 1, wherein the first validation message includes the first attribute value.

11. The method of claim 1, wherein the method further comprises:
generating a third token for the second account associated with the second authorizing entity computer; and
assigning a second transaction rule to the third token.

12. The method of claim 1, wherein the method further comprises:
generating a third token for the first account associated with the first authorizing entity computer; and
assigning a second attribute to the third token.

13. A token service computer comprising:
one or more storage media storing instructions; and
one or more processors configured to execute the instructions to cause the token service computer to perform operations comprising:
generating a first token for a first account associated with a first authorizing entity computer, the first token associated with a first attribute;
generating a second token for a second account associated with a second authorizing entity computer;
assigning a first transaction rule to the second token;
assigning a first attribute value to the first attribute associated with the first token;
receiving a request to check the first attribute value of the first attribute against the first transaction rule; and
responsive to the first attribute value of the first attribute satisfying the first transaction rule:
transmitting a first validation message to the second authorizing entity computer.

14. The token service computer of claim 13, wherein the first transaction rule identifies a value to check against the first attribute.

15. The token service computer of claim 13, wherein the first attribute is indicated as restricted from sharing with the second authorizing entity computer.

16. The token service computer of claim 13, wherein the first validation message includes the first attribute value.

17. The token service computer of claim 13, wherein the one or more processors execute the instructions to cause the token service computer to perform operations further comprising:
generating a third token for the second account associated with the second authorizing entity computer; and
assigning a second transaction rule to the third token.

18. The token service computer of claim 13, wherein the one or more processors execute the instructions to cause the token service computer to perform operations further comprising:
generating a third token for the first account associated with the first authorizing entity computer; and
assigning a second attribute to the third token.

19. The token service computer of claim 13, wherein the first transaction rule is assigned based on an indication received from the second authorizing entity computer.

20. One or more non-transitory computer-readable storage media storing instructions that, upon execution by one or more processors of a system, cause the system to perform operations comprising:
generating a first token for a first account associated with a first authorizing entity computer, the first token associated with a first attribute;
generating a second token for a second account associated with a second authorizing entity computer;
assigning a first transaction rule to the second token;
assigning a first attribute value to the first attribute associated with the first token;
receiving a request to check the first attribute value of the first attribute against the first transaction rule; and
responsive to the first attribute value of the first attribute satisfying the first transaction rule:
transmitting a first validation message to the second authorizing entity computer.
